(19) United States
(12) Patent Application Publication
(10) Pub. No.: US 2010/0040301 A1
(43) Pub. Date: Feb. 18, 2010

(54) IMAGE PROCESSING METHOD WITHOUT PARAMETERS

(75) Inventors: Kurt Osterloh, Berlin (DE); Uwe Ewert, Teltow (DE); Uwe Zscherpel, Glienicke (DE); Oleksandr Alekseychuk, Berlin (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: Bam Bundesanstalt Fuer Material Forschung Und-Pruefung, Berlin (DE)

(21) Appl. No.: 12/373,419

(22) PCT Filed: Jul. 17, 2007
(86) PCT No.: PCT/EP07/57385

§ 371 Date: Aug. 11, 2009

(30) Foreign Application Priority Data
Jul. 20, 2007 (DE) 10 2006 034 132.5

(51) Int. Cl. G06K 9/40

(52) U.S. Cl. 382/260

(57) ABSTRACT

The aim of the invention is to provide a method that increases the discernibility of fine structures in an input image and that suppresses noise. Said method comprises the following steps: calculation of a Fourier-transformation I(k) of the input image; calculation of a scaled power spectrum Pₛₖ(k) from the Fourier transformation; calculation of a noise function R(k), the following equation R(k)=Psk(k) for ∥k∥>ks being true for the higher frequencies k of said function above a predetermined threshold frequency kₛ; calculation of a differential function D(k)=Pₛₖ(k)−R(k); calculation of a filter function according to F(k)=α ∥k∥ D(k); multiplication of the Fourier transformation I(k) with the filter function F(k) and subsequent execution of an inverse Fourier transformation (30) for calculating a reconstructed image Ir(r).

A number of image processing algorithms and entire computer programs are known in the art, which have the objective of suppressing noise in digitized input images and enhancing the perceptibility of fine details.

All these have in common that the regions to be selected must be set by parameters, for example by inputting numbers or by moving virtual control knobs in a graphic user interface. Because of the user will not know the optimal parameter selection in advance and sub-optimal settings produce undesirable results, standard settings are frequently preset. Such universal preset provides in most cases an unsatisfactory solution when the input images are quite different.

The most basic selection of parameters includes brightness and contrast settings, because these are already part of the visual adjustment of a display screen. To extract from the image additional information which is not yet perceptible, filter techniques for digital images have been developed which affect the signal-to-noise ratio and correlate adjacent pixels. These include smoothing routines for noticeably noisy images as well as edge enhancement by difference formation (e.g., Laplace filtering, Embossed and Pseudoplast-representations, respectively). The degree of smoothing or enhancement of edge structures is controlled by user-defined settings of numerical values of parameters. The user must frequently also make an additional decision about the form of the corresponding filters. The user has greater difficulty handling all these adjustments than just the more intuitive brightness or contrast adjustments. Optimal results are frequently only attained after the user has gained certain experience. The sequential application of several different methods rarely leads to an optimal solution. It has been observed that repeated processing of the same image can produce quite different results.

In the digital radiography, fine details are frequently much more important than illumination of a large area. The latter may even be an impediment if in one region well illuminated fine structures are masked by brighter image regions and obscured in a darker image regions. Similar fine structures are equally present in bright and dark image regions due to their large dynamic brightness range which may extend over several orders of magnitude in digital images. It becomes then a goal of image processing to remove dynamic variations over large areas, without blurring details. One possible technique is to subtract from the original image a strongly smoothed image, which, however, requires a smoothing parameter. More complex high-pass filters require two parameters: the size of the filter core and the filter shape. Overall, there exists a wide selection of methods and procedures for digital filtering.

The ability to perceive details in an image is limited by noise. In unfavorable cases, for example in radiography through thick layers with a high contribution from scattered radiation, even coarser details can no longer be unambiguously identified. This problem occurs in practice, for example, with transmission radiograms of cast parts. To better identify faults, the images are typically high-pass filtered which, however, exacerbates the effects due to noise. This can be prevented by applying different methods, for example median or Gaussian filtering. The selection of the filter parameters is hereby somewhat arbitrary and the performed filtering can rarely be seen objectively as being optimal or reproducible.

DE 103 25 632 discloses a method for improving the perceptibility of structures of transmission radiograms, wherein the intensity distribution of a transmission image is Fourier-transformed and the intensity distribution in the frequency domain is filtered by changing the weighting between contributions from high-frequency and low-frequency image signals, wherein the image signal contributions with the greater weight are defined by taking into account an average structure size of those structures whose perceptibility is to be improved. In this way, for example, soft tissue structures can be identified in x-ray images.

This approach has the disadvantage that a parameter must be set which depends on the average structure size of the structures to be resolved, and that problems associated with noise generally become worse.

It is an object of the invention to provide a method which, on one hand, increases the perceptibility of fine structures in an input image and, on the other hand, suppresses noise. More particularly, it is an object of the invention to provide a method which does not require a user to set parameters or to select a menu. The image should be processed in a single pass and not require iterations, for which abort or end criteria would have to be defined.

The object is attained with the invention by a method having the features recited in claim 1.

The method of the invention for processing an input image I (r) includes the following method steps: computing a Fourier transform I (k) of the input image; computing a scaled power spectrum Pₛₖ (k) from the Fourier transform; computing a noise function R (k), wherein for its high frequencies k above a predetermined limit frequency k,: R (k)=Pₛₖ (k) for ∥k∥>kₛ; computing a difference function D(k)=Pₛₖ (k)-R(k); computing a filter function according to F (k)=α ∥k∥ D (k); multiplying the Fourier transform I(k) with the filter function F(k), and subsequently performing an inverse Fourier transformation for computing a reconstructed image Iᵣ (r).

Function values which slightly deviate from the aforementioned relations, i.e., such function values which are different from the claimed function values within a range of 10%, have the same effect and are viewed to be equivalent within the context of the invention. By subtracting the noise distribution from the scaled power spectrum, which is obtained, on one hand, for high frequencies directly from the values of the scaled power spectrum and, on the other hand, by multiplying the difference function with a function which increases linearly in the frequency domain, a compromise is achieved: the predominantly high-frequency noise in the input image is suppressed, whereas at the same time fine structures are enhanced at the expense of dynamic differences over large areas. The method of the invention takes into account the dynamic properties of the entire image, not only those of partial regions. The image is processed in a single pass, without requiring the user to determine processing parameters. Thereafter, only fine corrections of the brightness or contrast settings may be required. The filter function is determined based on the noise in the image, so that the method is exactly reproducible.

In the context of the invention, the term “scaled power spectrum” refers to a function which is derived from the simple power spectrum of the Fourier transform by simple scaling or transformation, e.g., by computing the logarithm or the root, wherein in the latter case the scaled power spectrum represents the amplitude spectrum of the Fourier transform. Above the predetermined limit frequency kₛ, the functional dependence of the scaled power spectrum is interpreted as pure noise. The noise function R (k), which represents an estimate of the noise distribution in the input image, then assumes for high frequencies above the predetermined limit frequency the same function values as the scaled power spectrum.

Preferably, the limit frequency kₛ is kₛ=kₘₐₓ/2, wherein kₘₐₓ is the minimum frequency determined by sampling of the input image I(k) in a coordinate direction kₓ or k_{y}. This specific selection can be interpreted in the spatial domain, before the Fourier transformation is performed, so that all intensity variations between two adjacent pixels are viewed as caused by noise, whereas variations over larger distances are viewed as information.

According to a preferred embodiment of the invention, the function values of the noise function R (k) at low frequencies ∥k∥<k, are computed by extrapolating the function values of the noise function at high frequencies ∥k∥>kₛ. In this way, all frequencies greater than the limit frequency are associated with noise and continued accordingly into the low-frequency regions.

When uniform isotropic noise is present and the pattern does not have a preferred direction, one of the functions Pₛₖ (k), R (k ), D (k ) or F (k) is advantageously averaged over all directions. This means that one of the aforementioned functions has the same values for all frequencies with k=const. After one of the aforementioned functions is averaged, which is then rotationally symmetric, all other functions computed during the further process flow are then also rotationally symmetric.

Preferably, a sliding average is computed for one of the functions Pₛₖ (k), R (k), D (k) or F(k). When one of the aforementioned function is smoothed, another function computed in the subsequent process flow is also smoothed. Sliding averaging prevents fine oscillations in the filter function to be computed, which would inevitably cause artifacts.

According to a preferred embodiment, if the signal-to-noise ratio is direction-dependent (anisotropic), one of the functions Pₛₖ (k), R (k), D (k) or F (k) is convoluted with a Gaussian function for smoothing. The convolution with a Gaussian function results in the formation of an average in both the radial and the axial direction, unless the type of noise distribution or the intensity distribution in the input image suggests a rotationally symmetric filter function.

Additional preferred embodiments of the invention are recited as features of the dependent claims.

An exemplary embodiment of the invention will now be described with reference to the appended drawings.

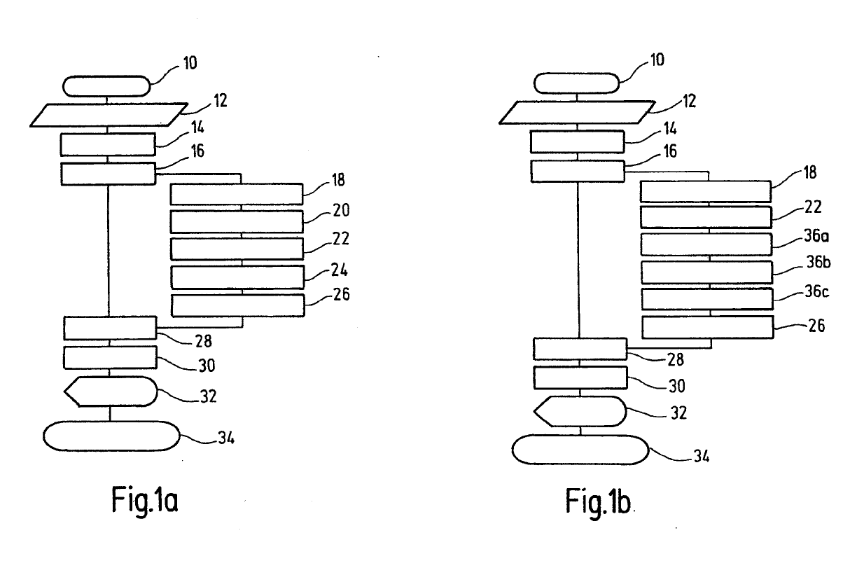

FIGS. 1a, b show flow diagrams for illustrating the method of the invention (A: isotropic case, B: anisotropic case), and

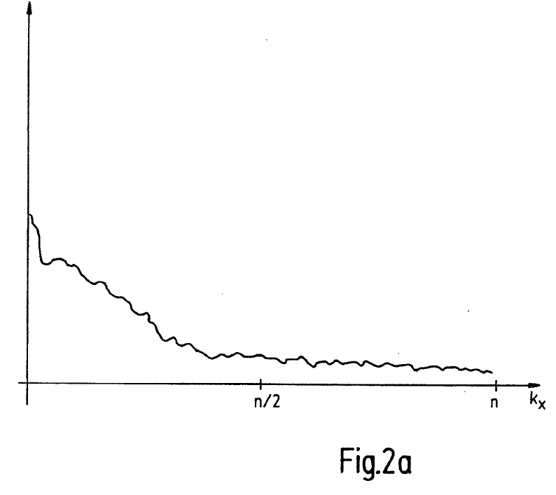

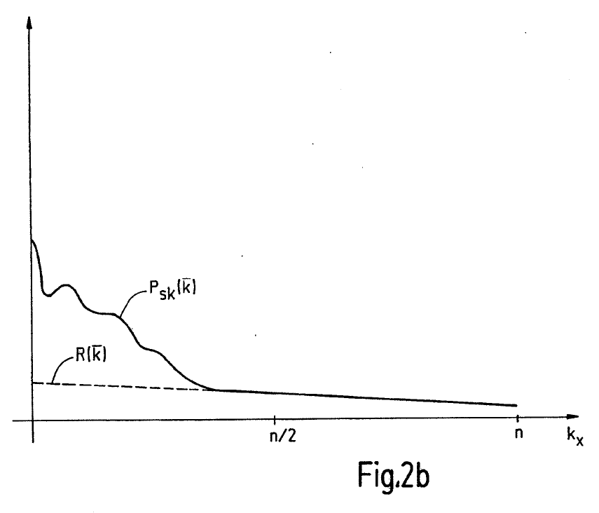

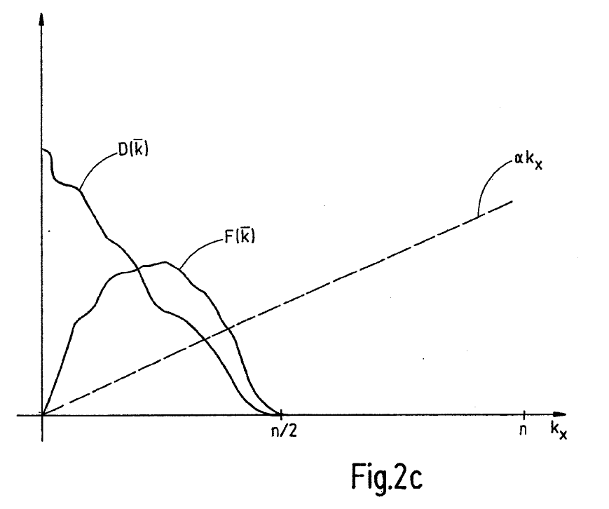

FIGS. 2a, b, c show the functional dependence of the functions Pₛₖ (k), R (k), D(k) and F(k).

FIG. 1a shows a flow diagram of the method of the invention, which applies when both the noise distribution and the structures of interest in the input image are sufficiently isotropic, i.e., independent of the direction. At method step 10, the computer program of the invention is invoked by the user. An input image in digital form which has n*n pixels and the intensity distribution I (r) is read (method step 12). At method step 14, the Fourier transform I (k) of the input image is duplicated and copied to a separate array of pixels, and a suitable filter function can be computed from the Fourier transform I (k) by applying the method of the invention (method steps 18, 20, 22, 24, 26). At method step 18, a scaled power spectrum Pₛₖ (k) is computed from the Fourier transform. An appropriate choice of the scaled power spectrum is the logarithm of the square of the magnitude of the Fourier transform of the input image. Because an isotopic filter is to be computed, the scaled power spectrum is averaged over all directions at method step 20, producing a rotationally symmetric function. At method step 22, a noise correction is performed, wherein a noise function R (k) is computed which is for high frequencies k>n/2 equal to the scaled power spectrum. The low frequencies of the noise function are estimated and extrapolated from the functional dependence at high frequencies. Thereafter, the difference between the scaled power spectrum Pₛₖ (k) and the noise distribution R (k) is formed. The resulting function still has fine oscillations which are undesirable and cause artifacts in image reconstruction. A sliding average value of adjacent pixels is therefore formed at method step 24. The function smoothed in this manner is multiplied at method step 26 with a function that increases linearly with ∥k∥, corresponding to high-pass filtering. In a two-dimensional representation, the function with which the difference function D (k) is multiplied consists of a straight line through the origin, whereas in a three-dimensional representation a rotation of this function about the axis through the origin results in a shape of an inverted cone. In the field of tomography, this filter is also referred to as Ramachandran-Lakshminarayanan filter. The filter function F(k) computed in this manner is multiplied at method step 28 with the Fourier transform I (k), an inverse Fourier transform is then performed (method step 30), whereafter the intensity distribution Iᵣ (k) of the reconstructed image is displayed to the user, at method step 32. The method of the invention then ends (method step 34).

FIG. 1b shows a flow diagram for performing the method of the invention in a situation where a rotationally symmetric filter function F(k) is not to be computed, where averaging over all directions is not advisable because the noise distribution or intensity distribution in the input image is anisotropic without a preferred direction. The method steps 20 and 24 of FIG. 1a are then omitted. In order to still appropriately smooth the filter function F(k), a convolution with a suitable Gaussian function is performed in additional method steps 36A, B, C. With the computer program of the invention, a Fourier transformation is performed (36A), the resulting function is then multiplied with a Gaussian function (36B), and an inverse Fourier transform is applied to the resulting function (36C).

The reconstructed image displayed in method step 32 has frequently extremely high and low single values. Brightness and contrast can be practically adjusted by eliminating extreme values and by selecting only a center region (for example a 95% region of the intensity distribution) which is then imaged on the image output format.

FIG. 2a shows an exemplary functional dependence of the scaled power spectrum of a noisy input image along a frequency coordinate kₓ which has n picture elements. The example relates to a one-dimensional input image, but can be readily generalized to two or more dimensions. A suitable selection of the scaled power spectrum is the logarithm of the square of the magnitude of the Fourier transform of the input image. The functional dependence is smoothed to eliminate rapid oscillations, resulting in the shape illustrated in FIG. 2b (Pₛₖ (k)). At an additional method step, a noise function R (k) is determined which coincides with Pₛₖ (k) for kₓ>n/2. For low-frequency function values, the functional dependence is suitably extrapolated from the high-frequency function values. Because in a logarithmic representation the noise distribution is approximately linear for high frequencies, the same is true for the high frequencies of the scaled power spectrum, so that the noise function R (k) can be closely approximated by a straight line (see FIG. 2b). At an additional method step, the difference function D(k)=Pₛₖ (k)-R(k) is determined (FIG. 2c), which becomes zero for kₓ>n/2. Finally, the filter function F (k) is produced by multiplying the difference function D (k ) with a linear function αkₓ.

### LIST OF REFERENCE SYMBOLS

10 start
12 output of the digitized input image
14 Fourier transform
16 duplication
18 computation of the scaled power spectrum
20 averaging over all directions
22 noise correction
24 computation of the sliding average
26 Ram-Lac filter
28 multiplication
30 inverse Fourier transformation
32 image display
34 end
36A, B, C convolution with a Gaussian curve

1. Method for processing an input image I (r), comprising the following method steps:
computing a Fourier transform I (k) of the input image;
computing a scaled power spectrum Pₛₖ (k) from the Fourier transform;
computing a noise function R (k), wherein for its high frequencies k above a predetermined limit frequency kₛ: R (k)=Pₛₖ (k) for ∥k∥>kₛ,
computing a difference function D (k)=Pₛₖ (k)−R (k);
computing a filter function according to F (k)=α∥k∥D(k);
multiplying the Fourier transform I (k) with the filter function F (k) and subsequently performing an inverse Fourier transformation (30) for computing a reconstructed image Iᵣ (k).

2. Method according to claim 1, wherein the scaled power spectrum Pₛₖ (k) is: Pₛₖ (k) =ln|I (k)|².

3. Method according to claim 1, wherein the limit frequency kₛ: kₛ=kₘₐₓ/2, wherein kₘₐₓ is the minimum frequency determined by sampling the input image I (k) in a coordinate direction kₓ or k_{y}.

4. Method according to claim 1, wherein the computation of the noise function R (k), its function values for low frequencies ∥k∥<kₛ are extrapolated from those of the noise function for high frequencies ∥k∥>kₛ.

5. Method according to claim 1, wherein one of the functions Pₛₖ (k), R (k), D (k) or F (k) is averaged over all directions.

6. Method according to claim 1, wherein one of the functions Pₛₖ (k), R (k), D (k) or F (k) a sliding average is computed.

7. Method according to claim 1, wherein one of the functions Pₛₖ (k), R (k), D (k) or F (k) is convoluted with a Gaussian function for smoothing.

8. Computer-readable medium with one or several command sequences stored thereon for causing one or several processors to execute the method steps recited in claim 1.

9. Computer program, which enables a computer, after the program is loaded into a memory of the computer, to perform a method according to claim 1.
